(19) United States
(12) Patent Application Publication
(10) Pub. No.: US 2014/0232342 A1
(43) Pub. Date: Aug. 21, 2014

(54) PORTABLE MOTION ACTIVATED CELL PHONE CHARGER UTILIZING A SHELLED TORUS PERMANENT MAGNET GENERATOR

(71) Applicant: Randal Scott Turner, Granite falls, WA (US)

(72) Inventor: Randal Scott Turner, Granite falls, WA (US)

(21) Appl. No.: 13/767,887

(22) Filed: Feb. 15, 2013

(51) Int. Cl. H02J 7/00; H02J 7/14

(52) U.S. Cl. CPC H02J 7/0042; H02J 7/1461
USPC 320/114

(57) ABSTRACT

A portable motion activated cell phone charger utilizing a shelled torus permanent magnet generator to generates electricity by kinetic energy imparted by the user if strapped to the arm or leg when jogging or may also be waved in the hand in an oscillating motion to generate electricity which is stored in a rechargeable battery within the charger assembly of which has a control circuit board with universal serial port attached and accessible from the exterior body casing allowing the user to connect a cell phone or small electronic devices with a universal serial bus cable to power the device or charge a battery within said device.

### CROSS REFERENCE TO RELATED APPLICATION

The present Application is related to co-pending Patent Application entitled “Hollow ring torus magnet generator,” filed 27 Sep. 2010 and assigned filing number Ser. No. 12/891,788, incorporated herein by reference in its entirety.

### BACKGROUND OF THE INVENTION

### Field of Invention

The present invention relates generally to a portable hand held dynamo cell phone charger, and more particularly, to a portable human powered cell phone charger assembly that utilized a shelled torus permanent magnet generator to charge or supply power to cell phones, mp3 players and other small hand held electronic devices.

Similar devices are already in use today for charging small hand held electronic devices that require low voltage and incorporate a rechargeable battery within their housing allowing them to supply power or charge the batteries within these devices when they are drained of power.

The problem with current hand held dynamo chargers is they require a hand crank for instance U.S. Pat. No. 6,914,340 incorporates a hand crank to generate electricity which requires both hands to crank the handle to activate the generator within and internal gearing both of which are susceptible to breakage, while U.S. Pat. No. 8,093,731 uses a pull sting to activate the generator within an assembly also requiring use of both hands to activate of which uses a pull string susceptible to breaking for transferring physical energy employed by the hands, U.S. Pat. No. 7,893,551 has a trigger you squeeze with your hand with internal gearing and with a linear permanent magnet generator like that used in patent application Ser. No. 12/917,617 only generates electricity if shaken in a linear motion as an example, a linear motion hand held generator will not operate in an application in which external spinning or rotating forces act on the generator, as the result would be to cause the magnet to remain at one end of the linear motion generator while the generator is being rotated or spun., with solar chargers such as patent application Ser. No. 10/587,654 it is limited to charging during day light hours.

What is needed is a hand held cell phone charger that can produce electricity without requiring both hand and has no exterior moving component or internal gearing that can bind up or wear out and which can also be fixed to the users arm or leg and not require hands to activate the generate.

### SUMMARY OF THE INVENTION

The present invention has solved the problems cited above by not requiring an exterior hand crank to activate the generator or internal gearing apparatus but has the generator self-contained within the charger assembly utilizing kinetic energy imparted to the assembly forcing a magnet to spin through coils formed around the circumference of a shelled torus housing with poles of the magnet aligned diametrically so north and south poles rotate while the magnet spins within the housing passing through spooled wire winding coils generating electricity without requiring hand crank, pull string and which does not require two hands to activate but instead can be activated with one hand making linear, lateral and or Oscillating motions to the charger assembly to activate the shelled torus generator which is encapsulated within and removes any worry of damage to exterior moving parts,

It also solves the problems found with using a linear generator of only generating electricity when shaken in a linear motion by utilizing a shelled torus permanent magnet generator which allows electricity to be generated from linear, lateral and or an oscillating motions and is not limited to a linear motion to generate electricity,

There has also not been a hand held dynamo cell phone charger invented or manufactured to date that produces electricity by means of a shelled torus generator which is activated by motion of the user and does not require an exterior cranking shaft, and/or internal gearing to activate the generator and supply current to charge the battery within the assembly and supply current to an exterior electronic device through USB connector.

Furthermore there has been no charger to date that can be attached to the users arm or leg and generate electricity by linear, lateral and or an Oscillating motion but have been limited to a linear motion to force a permanent magnet through insulated copper coils along a linear axes.

Furthermore, there exists a need for such a cell phone charger that can be activated without requiring both hands to impart motion but can be activated with one hand or hands free when attached to the leg of the user, hung around the neck or attached to a cap and placed on the head which makes it accessible to those users with a missing limbs etc.

Furthermore, there exists a need for such a cell phone charger that employs the use of such a generator in an effective easy to use manner in a variety of environments and conditions in a compact size with no worry of damaging exterior or internal moving parts.

Still further, there exists a need for such a cell phone charger that is durable and long lasting, yet that is economical to manufacture.

It should be noted that adding light emitting diodes, transmitter or mp3 player into the embodiment of this invention are obvious additions.

These and other features and advantages of the present invention will be more fully understood from the following detailed description with reference to the accompanying drawings.

### BRIEF DESCRIPTION OF DRAWINGS

FIG. 1 is a perspective view of a portable motion activated cell phone charger assembly utilizing a shelled torus generator in accordance with the present invention;

FIG. 2 is an exploded view of the portable motion activated cell phone charger assembly utilizing a shelled torus generator of FIG. 1, showing the components thereof in greater detail;

FIG. 3 is a perspective view of the lid, battery and removable battery holder of FIG. 2 showing these are mounted together in greater detail;

FIG. 4 is a Bottom perspective view the body housing showing its features thereof in greater detail;

FIG. 5 is a perspective view of the shelled torus generator assembly showing the components thereof in greater detail;

FIG. 6 is an explode view of the shelled torus generator body segments showing how they are mounted to one another and features therein greater detail;

FIG. 7 is a perspective view of the spool used in the generator assembly of FIG. 5 showing the features in greater detail;

FIG. 8 is a top view of a segment of the shelled torus body showing how the spool is mounted onto the body section of the generator assembly of FIG. 5;

FIG. 9 is a top view of the body housing of FIG. 1. 2 showing the features therein greater detail;

FIG. 10 is a top sectioned view of the shelled torus generator of FIG. 5 showing the internal workings of the magnet of FIG. 6 in greater detail;

FIG. 11 is a perspective view of the magnet of FIG. 6. 10 showing the alignment of the magnetic poles;

FIG. 12 is a perspective view of the control circuit board of FIG. 2 showing its features in greater detail;

FIG. 13 is a perspective view of the arm/leg strap of FIG. 2;

FIG. 14 is a perspective view of the portable motion activated cell phone charger assembly showing an alternate configuration with the addition of a solar cell on the lid segment.

FIG. 15 is a perspective view of the portable motion activated cell phone charger assembly showing an alternate configuration having a removable handle grip.

FIG. 16 is a block diagram showing the process of assembling the components therein.

### DETAILED DESCRIPTION

The following detailed description is of the best currently contemplated modes of carrying out the invention. The description is not to be taken in a limiting sense, but is made merely for the purpose of illustrating the general principles of the invention as will be described in greater detail below;

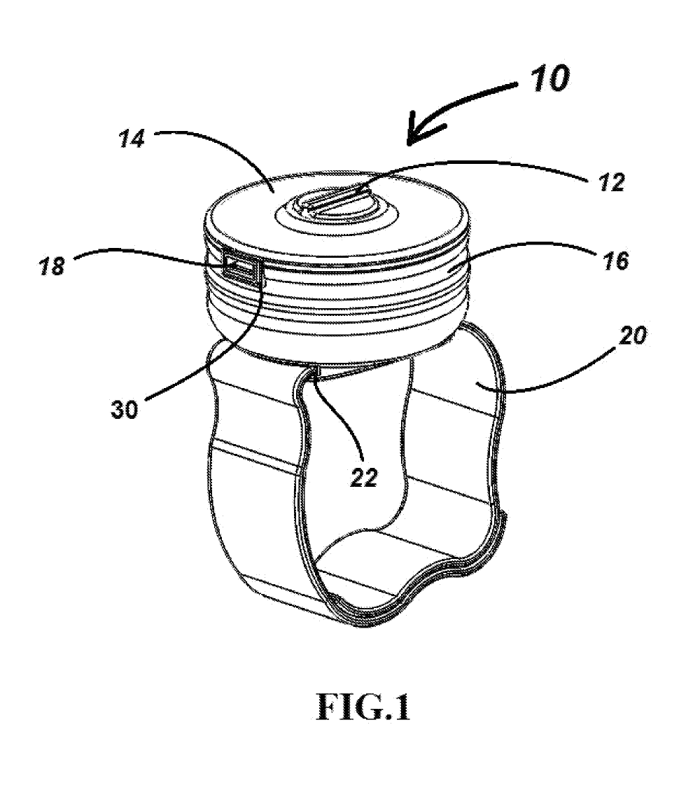

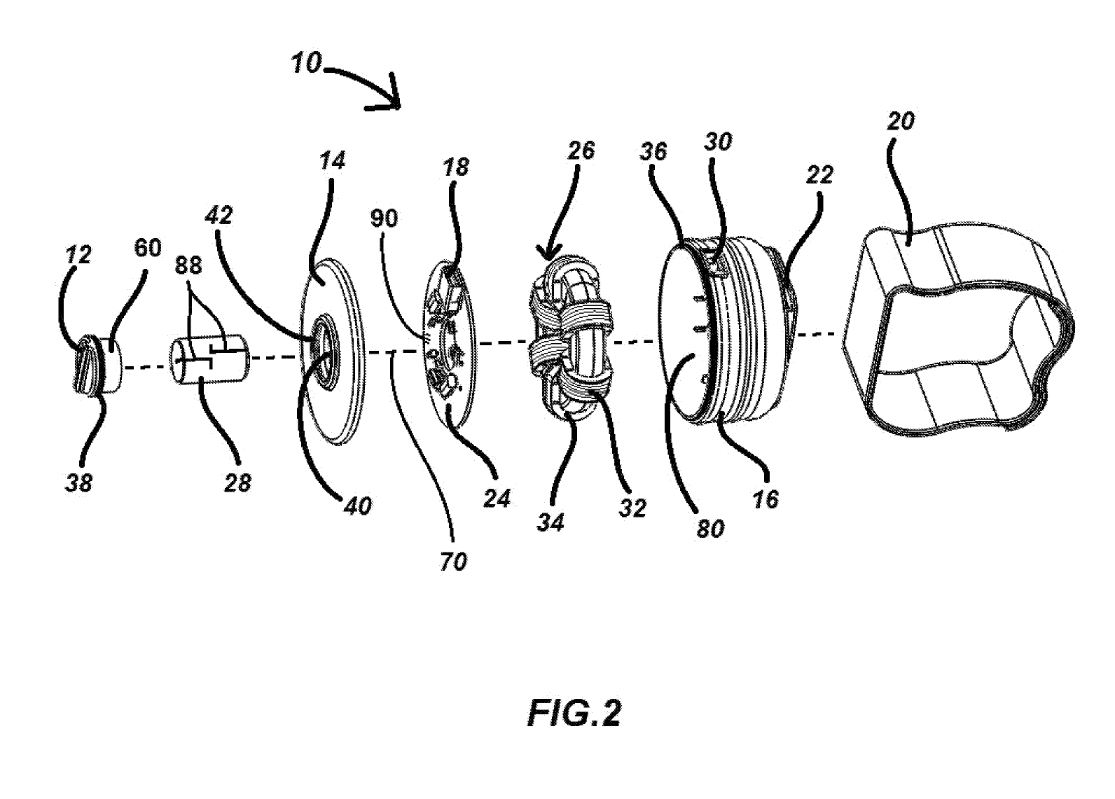

FIG. 1 shows portable motion activated cell phone charger utilizing a shelled torus generator 10, in accordance with the present invention; lid 14 is mounted to body housing 16 after all parts of the assembly are installed, with removable battery holder 12 mounted into center hole on lid 14 by screw threads 38 and 42 better seen in (FIG. 2),

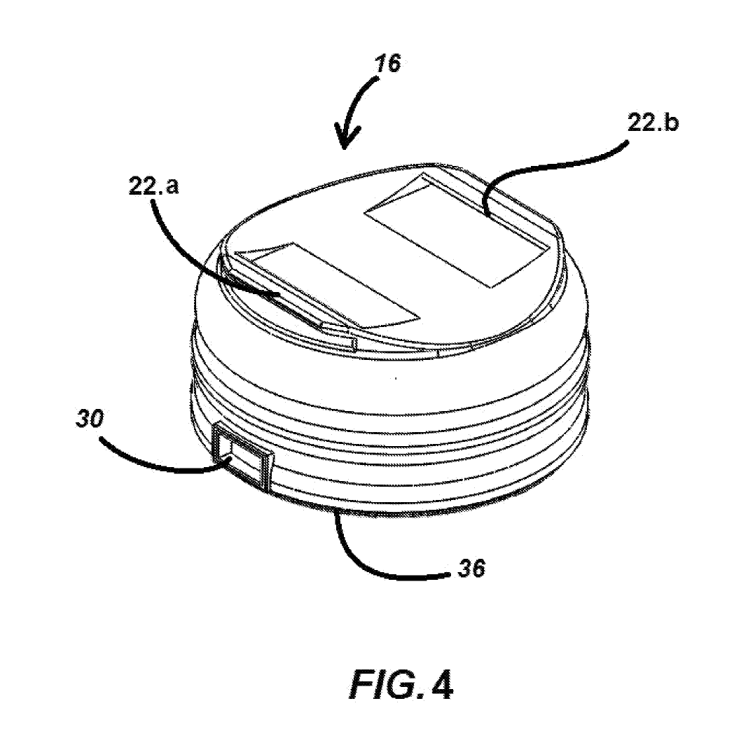

FIG. 2 universal serial bus port 18 protrudes through slot 30 on the side wall of body casing 16, arm strap 20 is fastened to the bottom/rear of body housing 16 through mounting brackets 22, as can be better seen in (FIG. 4) the portable motion activated cell phone charger utilizing a shelled torus generator is made up of seven principal subassemblies, i.e., a shelled torus generator 26 is electrically connected by wires 98 to control circuit board 24 which is electrically connected by wires 100 to rechargeable battery 28 and transfers electricity generated by shelled torus generator 26 through relay circuitry of control circuit board 24 to battery 28 which stores the electrical energy and is released when a cell phone or small electronic device is attached to universal serial bus port 18 which is electrically mounted/soldered to said control circuit board, these components 24,26,28 are then inserted into cavity 80 of the body housing 16 along axis 70 during which universal serial bus port 18 is inserted within receiving slot 30 so that it is protruding out from Body housing 16 making it accessible from the exterior of the assembly, lid 14 is screwed onto body housing 16 by corresponding threads to securely seal components within, arm strap 20 is fastened to mounting brackets 22.a 22.b on the rear/bottom portion of body housing 16, removable battery holder 12 is mounted by threads 38 into threads 42 on lid 14 along axis 70 into access hole 40 on lid 14 tightly coupling battery holder 12 onto one end of battery 28, so when holder 12 is removed it will pull the battery out through access hole 40 allowing battery 28 to be replaced if needed at a future time, wire 100 is supplied excess length allowing battery 28 to be pulled out of access hole 40 and replaced and reconnected to a new battery.

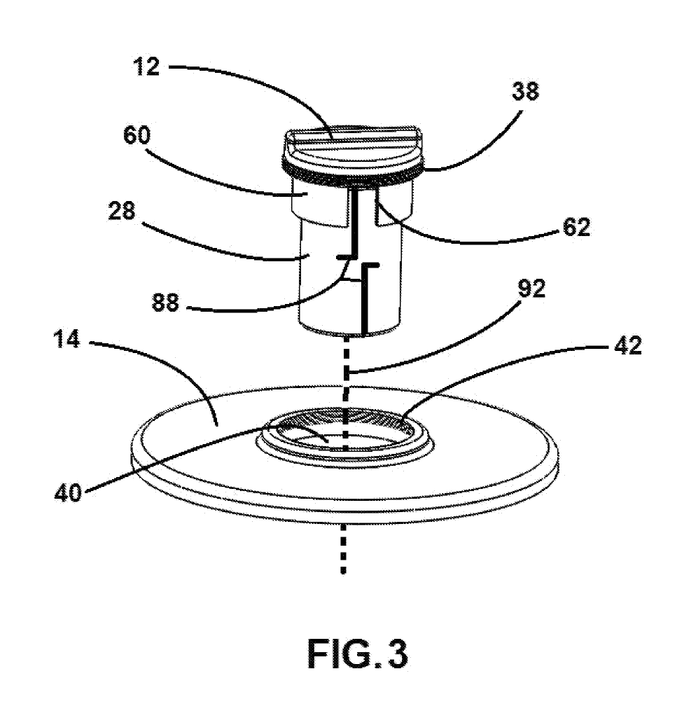

FIG. 3 battery 28 is forcibly mounted into recessed coupler 60 on the bottom of removable battery holder 12 holding it securely within, removable battery holder 12 is then mounted along axis 92 into opening 40 of lid 14 by threads 38 and 42.

FIG. 4 the mounting brackets 22.a.b allow fastening arm band 20 to the rear portion of body housing 16, slot 30 enables universal serial bus port 18 to protrude from the body housing allowing access to plug in a cell phones or other small electronic devices for charging using a usb cable.

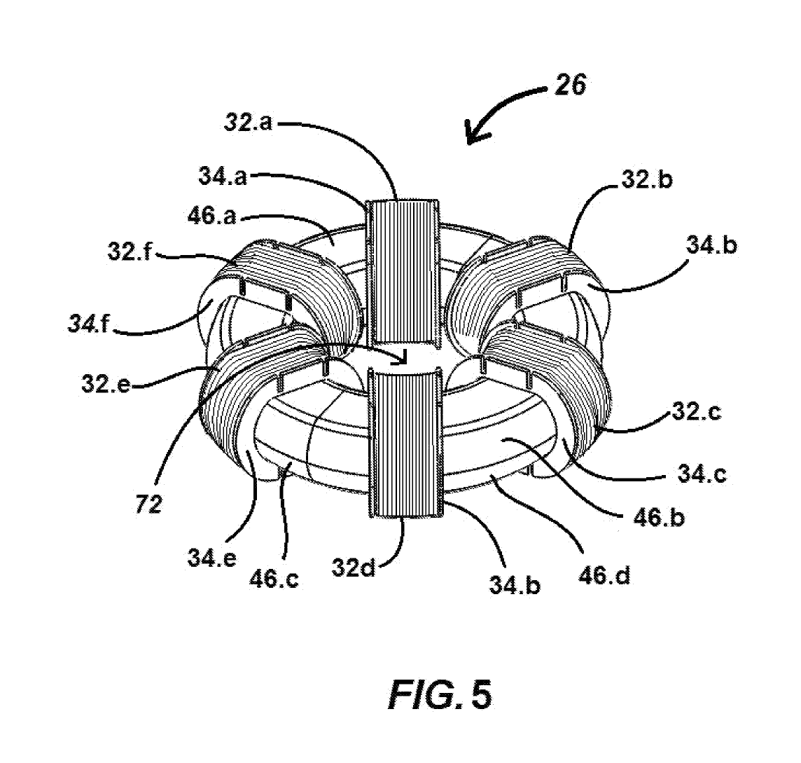

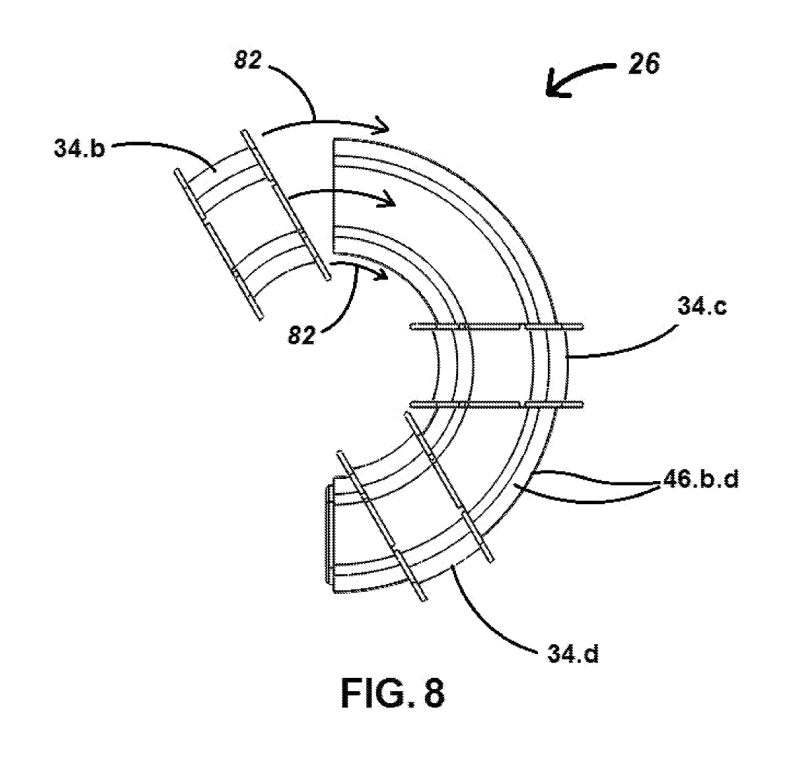

FIG. 5 the shelled torus generator 26 has sixteen sub-assemblies; body segments 46.d.b, are mounted to one another as are body segments 46.a.c. then spools 34.c.b.d, and wire windings 24.b.c.d, are mounted onto body segment 46.b.d by sliding the spools over the outer circumference of said body segments which is better illustrated in (FIG. 8) hole 72 shows the center portion of the generator assembly 26 allows room for rechargeable battery 12 along with wires 100 to fit within the center of the shelled torus generator assembly 26 when placed inside the body housing 16.

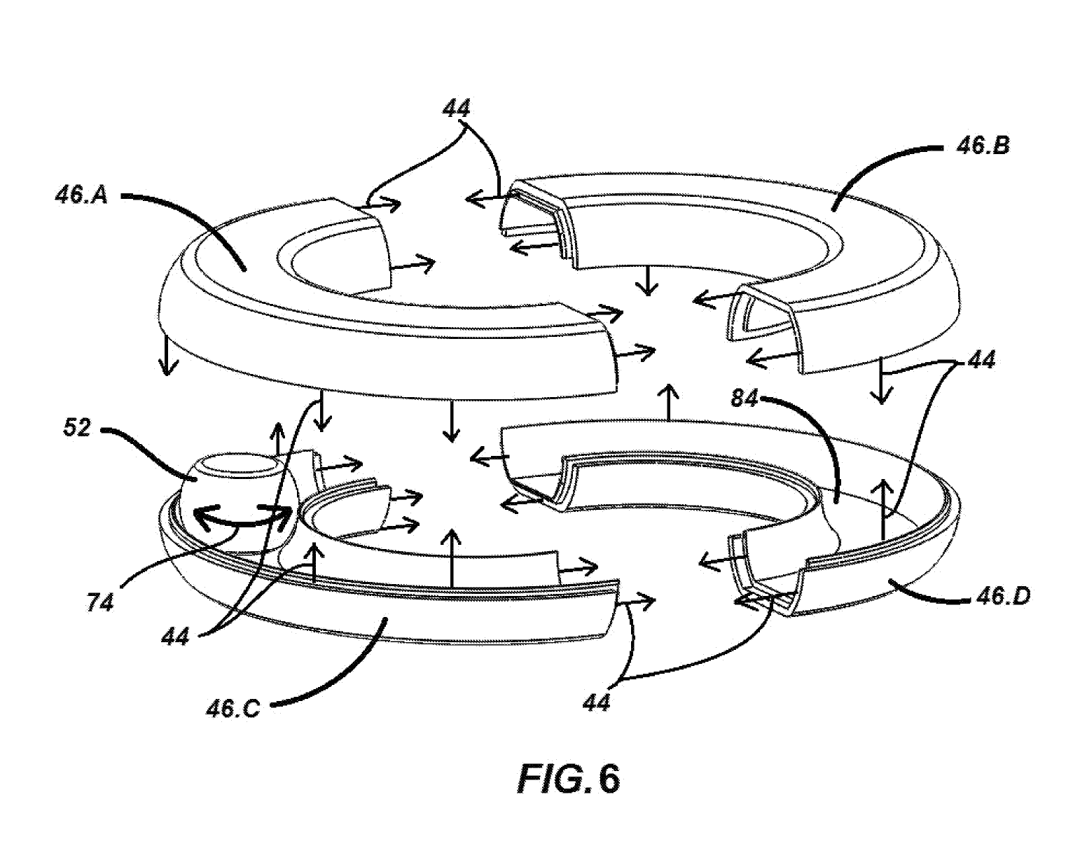

FIG. 6 the shelled torus generator main body sections 46.a.b.c.d have a shelled interior 84 allowing permanent magnet 52 to freely spin within in directions 74 when linear, lateral and or an oscillating motion is imparted to assembly 10.

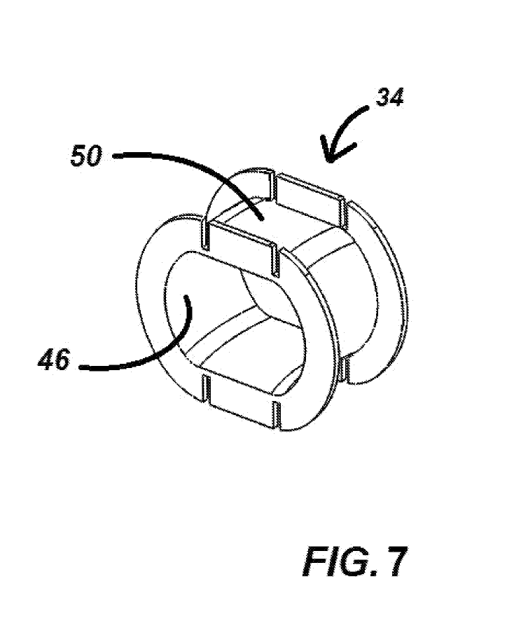

FIG. 7 spools 34.a.b.c.d.e.f have a contoured shelled interior through the center 46 for mounting onto the outer portion of shelled torus generator body segments 46.a.b.c.d with a channel 50 on the exterior allowing wire windings 32.a.b.c.d.e.f, to be wound around spools 34.a.b.c.d.e.f,

FIG. 8 illustrates how spool 34.b is mounted onto body segments 46.b.d along axis 82 during the assembly of shelled torus generator 26.

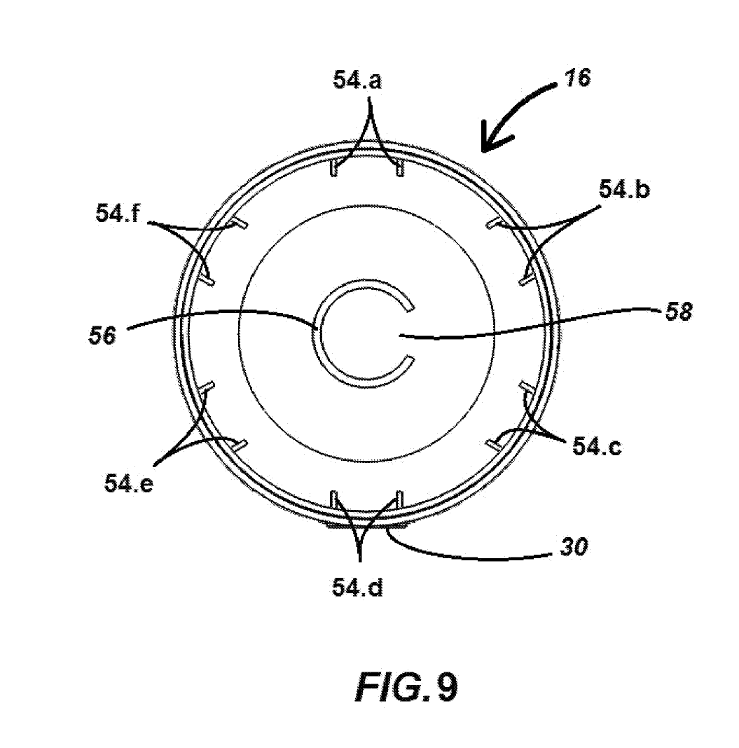

FIG. 9 ribs 54.a.b.c.d.e.f securely fit spools 34.a.b.c.d.e.f within body housing 16 to prevent generator 26 from moving or rattling within assembly 10 when in use, an extruded tube 56 loosely holds battery 28 allowing it to rest within and is easily removed and which has a cut section 58 allowing room for wiring 98 to be affixed to battery terminals 88 (see FIG. 3)

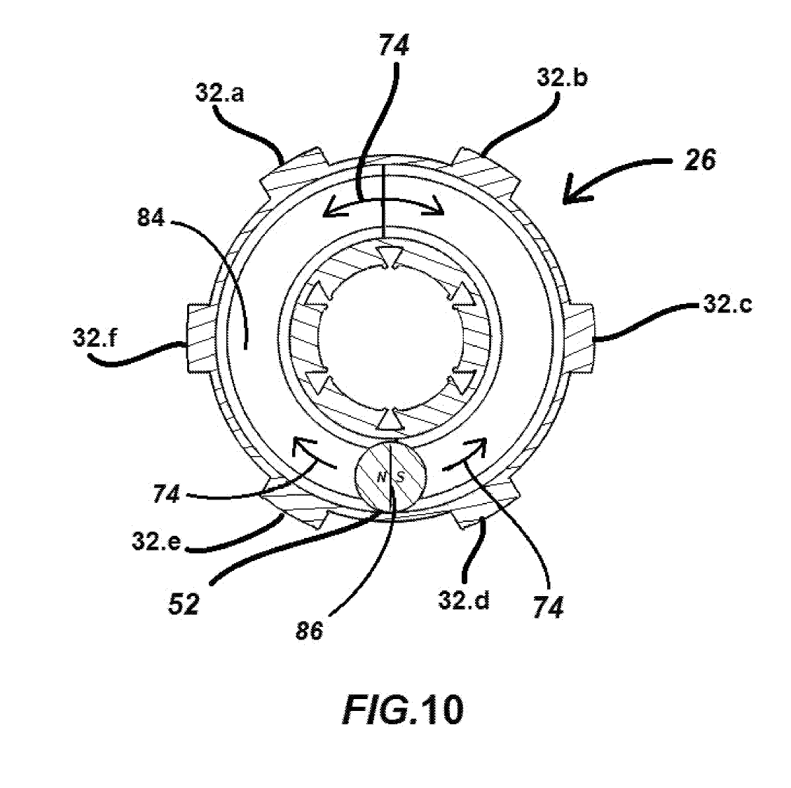

FIG. 10 permanent magnet 52 revolves around within shelled torus hollow inner chamber 84 in directions 74 when kinetic energy is imparted to assembly 10, diametrically aligned magnetic poles 86 spin/rotate as they pass through spooled wire winding coils 32.a.b.c.d.e.f knocking electrons free from said coil wire windings 32.a.b.c.d.e.f,

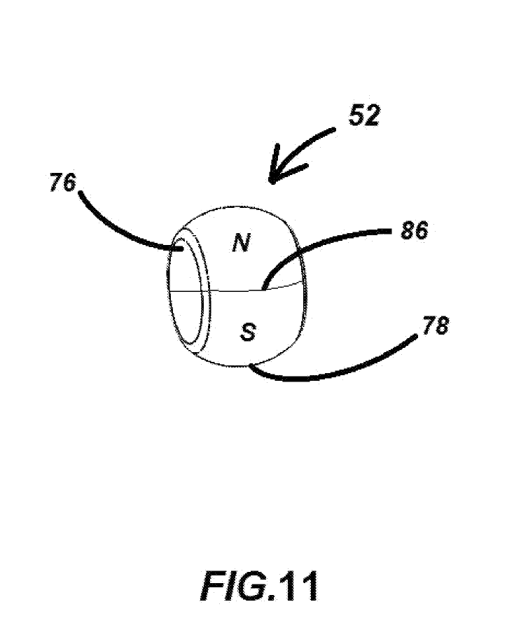

FIG. 11 permanent magnet 52 is magnetized with poles 86 aligned diametrically, flat surfaces 76 align the magnet within the shelled torus body segments 46.a.b.c.d as kinetic energy is imparted to assembly 10 magnet 52 spins within body segments 46.a.b.c.d with the rounded surface 78 spinning within the shelled torus chamber which allows the magnetic poles to flip/rotate as they pass through the spooled wire coils 32.a.b.c.d.e.f more effectively knocking electrons free from coils 32.a.b.c.d.e.f generating electricity which is transferred to terminals 90 on control circuit board 24

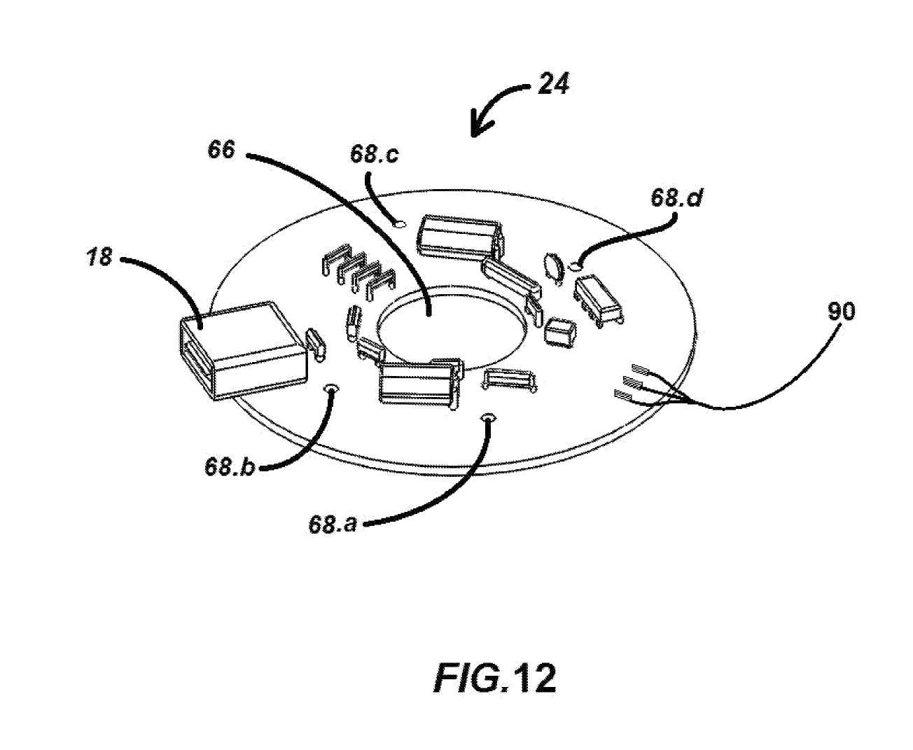

FIG. 12 terminals 90 are connected to spooled wire coils 32.a.b.c.d.e.f which transfer current through circuitry within the control circuit board that regulates the voltage so that it meets the voltage requirements of cell phones and other small electronic devices being charged,

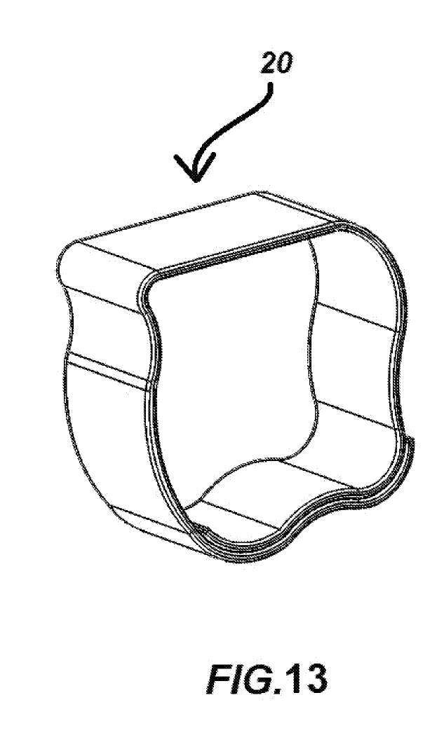

FIG. 13 displays an arm band 20 which is fastened to mounting brackets 22.a.b on the rear portion of body housing 16,

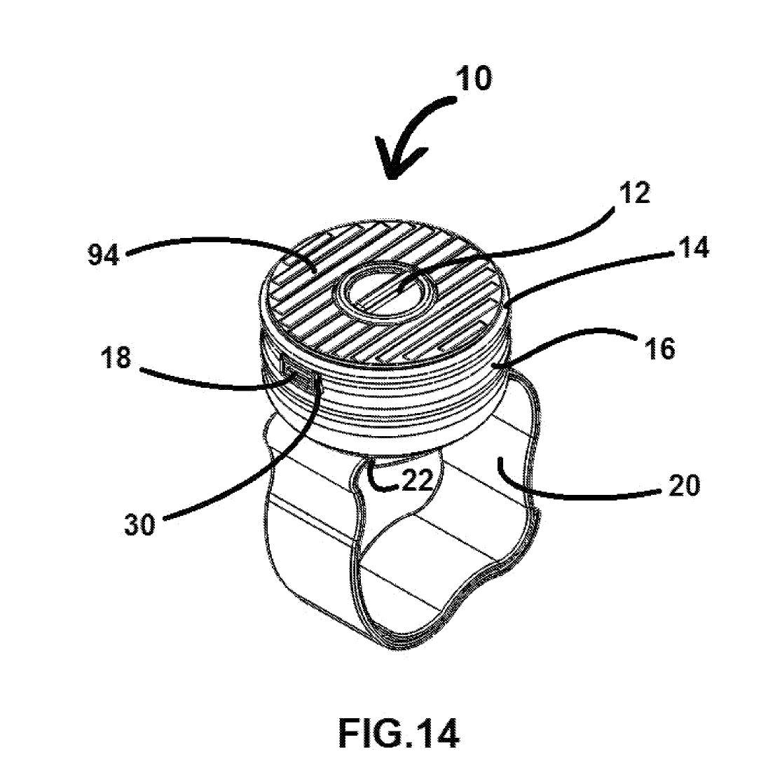

FIG. 14 displays an alternate configuration of the portable motion activated cell phone charger assembly 10 wherein a solar cell panel 94 is added to the lid 14 to supply additional electrical charging of charging rechargeable battery 28 when the assembly is at rest and sunlight is available,

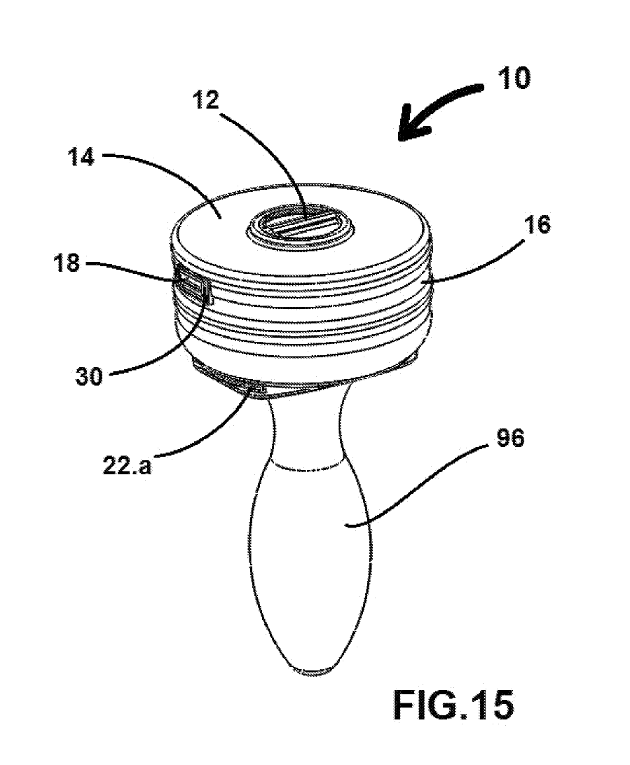

FIG. 15 displays an alternate configuration of the portable motion activated cell phone charger assembly 10 wherein a removable handle grip 96 is attached to mounting brackets 22.a.b allowing the user to impart motion more easily by waving assembly 10 when holding handle grip 96 to activate shelled torus generator 26 within assembly 10 charging battery 28.

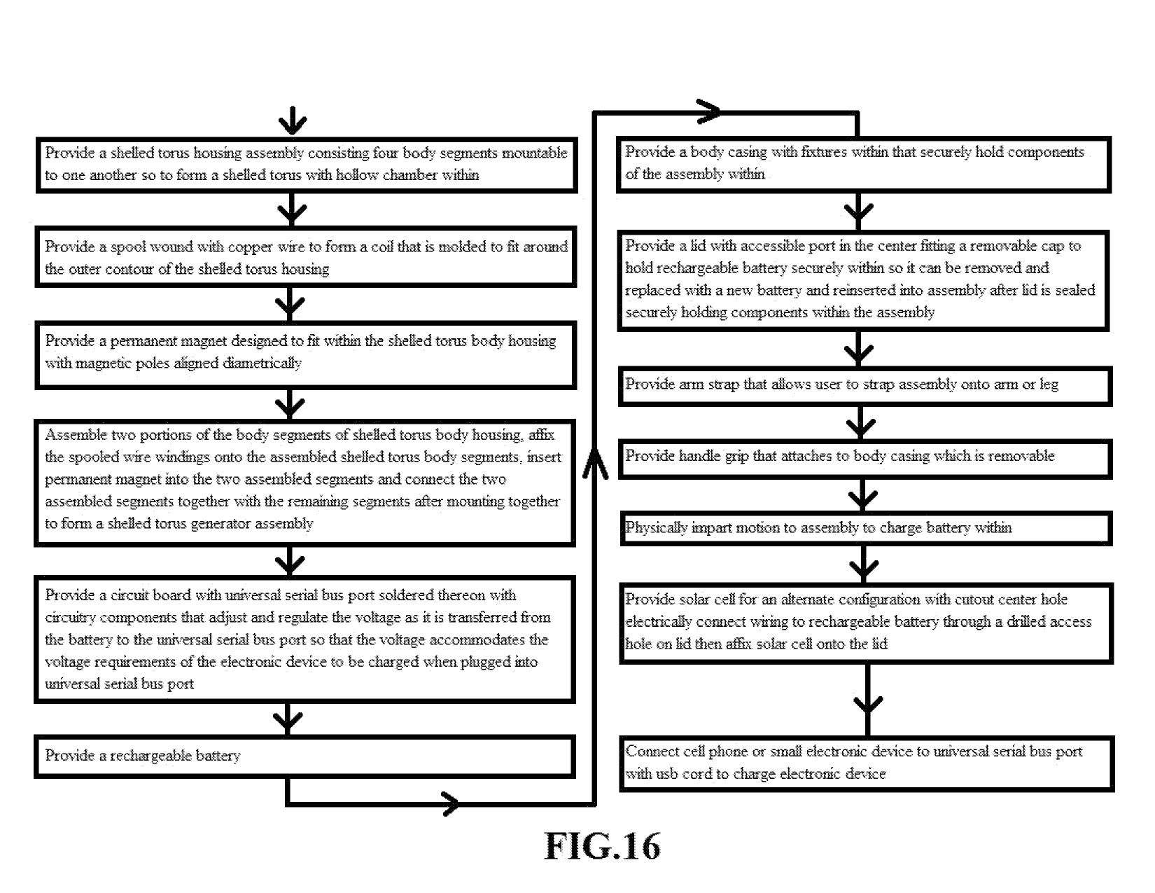

FIG. 16 displays a block diagram showing the process for assembling the components of the invention.

It is to be understood that the description herein is exemplary of the invention only and is intended to provide an overview for the understanding of the nature and character of the disclosed portable hand held cell phone charger utilizing a shelled torus generator systems. The accompanying drawings are included to provide a further understanding of various features and embodiments of the method and devices of the invention which, together with their description serve to explain the principles and operation of the invention.

What is claimed is:

1. A portable motion activated cell phone charger utilizing a shelled torus permanent magnet generator comprising:
a housing for containing all components of the assembly within,
a control circuit board which transfers electricity generated by a shelled torus permanent magnet generator to a rechargeable battery where it is stored then transferred at a regulated voltage to a universal serial bus port through said circuitry so to meet the voltage requirements of the cell phone or electronic devices being charged,
a rechargeable battery with protection circuit that shuts off the charging when fully charged to protect the battery from damage caused by overcharging and which prolongs the charging cycle life of the battery and of which battery is replaceable,
a universal serial bus port connected to said circuit board of which port is accessible from the exterior of said body casing allowing cell phones or small electronic devices to be electrically connected to said universal serial bus port.
a shelled torus permanent magnet generator comprising: a shelled torus generator having a hollow inner chamber therein; a permanent magnet located inside and movable within said hollow inner chamber; spooled wire winding coils affixed to the exterior of said shelled torus generator body of which wire is electrically connected to said circuit board so that as said magnet revolves within said shelled torus hollow inner chamber it passes through said wire coils so to generate electrical current which is transferred through said circuit board to supplying electrical charge to a rechargeable battery for storage within; a control circuit board which communicates electrical current through elements such as relays, capacitors, resistors regulating the voltage as it transfers to a universal serial bus port which is soldered to said circuit board; a rechargeable battery electrically connected to said control circuit board and of which rechargeable battery is replaceable when the charging cycle life is depleted; a strap allowing the assembly housing to be strapped to the users arm/leg; a removable handle grip attached to the housing for waving the assembly while holding the handle grip to impart motion to the assembly.

2. The portable motion activated cell phone charger assembly utilizing a shelled torus permanent magnet generator of claim 1, further comprising: means for connecting a cell phone or small electronic device by means of a universal serial bus connector.

3. The portable motion activated cell phone charger assembly utilizing a shelled torus permanent magnet generator of claim 2, wherein said universal serial bus port allows the user to connect a number of different types of small electronics devices and is not exclusive to connecting cell phones.

4. The portable motion activated cell phone charger assembly utilizing a shelled torus permanent magnet generator of claim 1, further comprising: means for replacing said rechargeable battery when the battery recharging life has been exhausted or may alternately be permanently affixed within the body casing.

5. The portable motion activated cell phone charger assembly utilizing a shelled torus permanent magnet generator of claim 5, wherein said permanent magnet revolves within the shelled torus inner chamber passing through coiled copper wire windings generating electricity.

6. The portable motion activated cell phone charger assembly utilizing a shelled torus permanent magnet generator of claim 1, wherein said means for imparting motion is accomplished using an arm/leg strap, waving with the handle grip or may also be shaken by hand without handle or strap.

7. The portable motion activated cell phone charger assembly utilizing a shelled torus permanent magnet generator of claim 1, wherein said universal serial bus port, circuit board and rechargeable battery consists of non-ferrous or low-ferrous materials so as not to attract and reduce movement of the permanent magnet within the shelled torus generator housing.

8. The portable motion activated cell phone charger assembly utilizing a shelled torus permanent magnet generator of claim 1, further comprising: mounting fixture on the exterior bottom/rear of the body casing allowing arm/leg strap or a hand grip to be connected.

9. The portable motion activated cell phone charger utilizing a shelled torus permanent magnet generator of claim 1 wherein the control circuit board is electrically connected to the spooled wire coils of said shelled torus generator, rechargeable battery and universal serial bus port of which circuit board transfers electricity generated by said generator to said battery where it is stored and transmitted when needed through circuitry on said circuit board to a universal serial bus port so that the output voltage is compatible with powering cell phones and other small portable electronic devices without worry of damaging circuitry of said devices.

10. The rechargeable battery of claim 1, further comprising a protection circuit that closes when the battery is fully charged and of which battery is replaceable when the charging cycle life is depleted by removing the battery holder cap located on the cell phone charger lid then removing said depleted battery and replacing it with a new rechargeable battery.

11. The portable motion activated cell phone charger utilizing a shelled torus permanent magnet generator of claim 1, wherein the shelled torus body, spools, body casing, lid, battery holder and hand grip of claim 1, may be constructed of any durable light weight non-magnetic material e.g. Aluminum, plastic, carbon fiber etc.

12. The motion activated cell phone charger assembly utilizing a shelled torus permanent magnet generator of claim 1, wherein it may be activated with one hand or strapped to the leg allowing hands free while it charges from the motion of walking or Jogging.

13. The motion activated cell phone charger assembly utilizing a shelled torus permanent magnet generator of claim 1, further comprising a removable handle grip allowing the user to activate the generator by waving the assembly with handle attached.

14. The spool of claim 1, wherein insulated copper wire is wound around the exterior of said spool to form a coil prior to being affixed to the exterior of the shelled torus generator body.

15. A cell phone charger which incorporates the use of a shelled torus permanent magnet generator.
